(19) United States
(12) Patent Application Publication
(10) Pub. No.: US 2024/0266921 A1
(43) Pub. Date: Aug. 8, 2024

(54) COOLER HAVING OPTIMIZED COATING STRUCTURE FOR ELECTRIC VEHICLE POWER MODULE

(71) Applicant: AMULAIRE THERMAL TECHNOLOGY, INC., New Taipei City (TW)

(72) Inventors: TZE-YANG YEH, New Taipei City (TW); YU-HSIANG LEE, New Taipei City (TW); HSUEH-LIN LU, New Taipei City (TW); KUN-LIN CHIH, New Taipei City (TW)

(21) Appl. No.: 18/163,851

(22) Filed: Feb. 2, 2023

(51) Int. Cl. H02K 9/22; C23C 28/02

(52) U.S. Cl. CPC H02K 9/22; C23C 28/021

(57) ABSTRACT

A cooler having an optimized coating structure for an electric vehicle power module is provided. The cooler includes a metal cooling substrate and a coating structure. The coating structure has at least a barrier layer and a function layer. The barrier layer is formed on the metal cooling substrate. The barrier layer is a nickel coating layer or a nickel alloy coating layer having a thickness of between 0.1 μm and 0.5 μm. The function layer is a silver/silver alloy coating layer, or a copper/copper alloy coating layer having a thickness of between 0.1 μm and 0.5 μm.

### FIELD OF THE DISCLOSURE

The present disclosure relates to a cooler for an electric vehicle, and more particularly to a cooler having an optimized coating structure for an electric vehicle power module.

### BACKGROUND OF THE DISCLOSURE

Conventional coolers for electric vehicles are mostly manufactured from metal with high thermal conductivities, and a metallic coating is formed on the coolers. However, when such coolers are used under high temperature and high pressure, migration and diffusion occurs between the metal atoms of the conventional cooler, causing the properties of the cooler to be negatively affected, and a lifespan of the cooler to be decreased.

### SUMMARY OF THE DISCLOSURE

In response to the above-referenced technical inadequacies, the present disclosure provides a cooler having an optimized coating structure for an electric vehicle power module.

In one aspect, the present disclosure provides a cooler having an optimized coating structure for an electric vehicle power module. The cooler includes a metal cooling substrate and a coating structure that is at least three-layered. The coating structure has at least a barrier layer, a connection layer, and a function layer. The barrier layer is formed on the metal cooling substrate, and is a nickel coating layer or a nickel alloy coating layer having a thickness of between 0.1 μm and 0.5 μm. The connection layer is formed on the barrier layer, and is a copper coating layer or a copper alloy coating layer having a thickness of between 0.1 μm and 0.5 μm. The function layer is formed on the connection layer, and is a silver coating layer or a silver alloy coating layer having a thickness of between 0.1 μm and 0.5 μm. The metal cooling substrate can be connected to an insulating substrate of the electric vehicle power module by sintering through silver or silver alloy of the function layer of the coating structure.

In certain embodiments, the metal cooling substrate is made of copper, copper alloy, aluminum, or aluminum alloy.

In certain embodiments, a surface of the metal cooling substrate has at least a platform structure, a protruded platform structure, or a recessed platform structure formed thereon.

In certain embodiments, the barrier layer is bonded to the metal cooling substrate by electroplating, electroless plating, chemical vapor deposition, or physical vapor deposition.

In certain embodiments, the connection layer is bonded to the barrier layer by electroplating, electroless plating, chemical vapor deposition, or physical vapor deposition.

In certain embodiments, the function layer is bonded to the connection layer by electroplating, electroless plating, chemical vapor deposition, or physical vapor deposition.

In another aspect, the present disclosure provides a cooler having an optimized coating structure for an electric vehicle power module. The cooler includes a metal cooling substrate and a coating structure that is at least two- layered. The coating structure has at least a barrier layer and a function layer. The barrier layer is formed on the metal cooling substrate, and is a nickel coating layer or a nickel alloy coating layer having a thickness of between 0.1 μm and 0.5 μm. The function layer is formed on the barrier layer, and is a copper coating layer or a copper alloy coating layer having a thickness of between 0.1 μm and 0.5 μm. The metal cooling substrate can be connected to an insulating substrate of the electric vehicle power module by sintering through copper or copper alloy of the function layer of the coating structure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of a cooler according to a first embodiment of the present disclosure;

FIG. 2 is a schematic view of a use state of the cooler according to the first embodiment of the present disclosure;

FIG. 3 is a schematic side view of a cooler according to a second embodiment of the present disclosure;

FIG. 4 is a schematic side view of another implementation of the cooler according to the second embodiment of the present disclosure;

FIG. 5 is a schematic side view of a cooler according to a third embodiment of the present disclosure;

FIG. 6 is a schematic side view of another implementation of the cooler according to the third embodiment of the present disclosure;

FIG. 7 is a schematic side view of a cooler according to a fourth embodiment of the present disclosure;

FIG. 8 is a schematic side view of a cooler according to a fifth embodiment of the present disclosure; and

FIG. 9 is a schematic side view of a cooler according to a sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

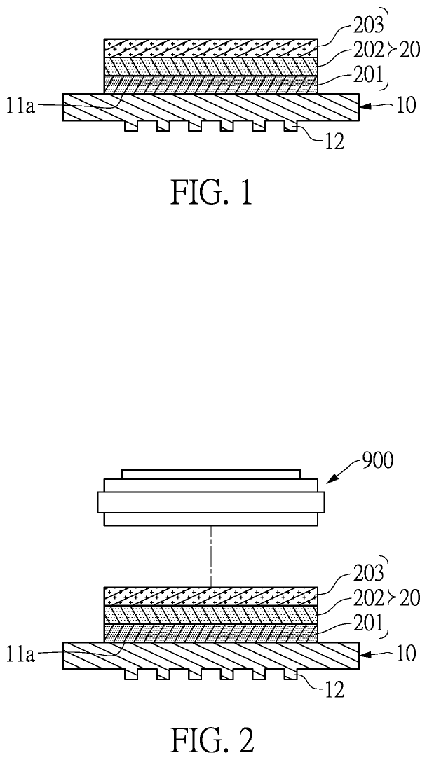

Reference is made to FIG. 1 and FIG. 2, in which one embodiment of the present disclosure is shown. The first embodiment of the present disclosure provides a cooler having an optimized coating structure for an electric vehicle power module. The cooler having an optimized coating structure for an electric vehicle power module according to the present disclosure includes a metal cooling substrate 10 and a coating structure 20 that is at least three-layered.

The metal cooling substrate 10 can be made of copper, copper alloy, aluminum, or aluminum alloy; furthermore, a top surface of the metal cooling substrate 10 has a platform structure 11a formed thereon. In this embodiment, the platform structure 11a can be formed on the top surface of the metal cooling substrate 10 through mechanical processing such as grinding. Furthermore, a bottom surface of the metal cooling substrate 10 can have a plurality of heat-dissipating bumps 12 formed thereon. The plurality of heat-dissipating bumps 12 can be integrally formed on the bottom surface of the metal cooling substrate 10 through mechanical processing such as skiving. In addition, the plurality of heat-dissipating bumps 12 can be integrally formed on the bottom surface of the metal cooling substrate 10 through forging or stamping.

The coating structure 20 can have at least a barrier layer 201, a connection layer 202, and a function layer 203. The barrier layer 201 is formed on the platform structure 11a of the metal cooling substrate 10, and can be bonded to the metal cooling substrate 10 by electroplating, electroless plating, chemical vapor deposition, or physical vapor deposition. The barrier layer 201 can increase a barrier capability of the coating structure 20, so as to impede the diffusion of metal atoms in the metal cooling substrate 10, and protect the platform structure 11a of the metal cooling substrate 10 from oxidation. Furthermore, the barrier layer 201 is a nickel coating layer or a nickel alloy coating layer having a thickness that is extremely thin. According to test results, the thickness of the barrier layer 201 needs to be at least between 0.1 μm and 0.5 μm to have a good barrier and protection effect. Moreover, because copper atoms have a faster diffusion speed than aluminum atoms, in this embodiment, the metal cooling substrate is preferably made of aluminum or aluminum alloy.

The connection layer 202 is formed on the barrier layer 201, and can be bonded to the barrier layer 201 by electroplating, electroless plating, chemical vapor deposition, or physical vapor deposition. The connection layer 202 can increase connectivity between the barrier layer 201 and the function layer of the coating structure 20, and can protect the barrier layer 201 from passivation. Furthermore, the connection layer 202 is a copper coating layer or a copper alloy coating layer having a thickness that is extremely thin. According to tests results, the thickness of the connection layer 202 needs to be at least between 0.1 μm and 0.5 μm to have a good connection and protection effect.

The function layer 203 is formed on the connection layer 202, and can be bonded to the connection layer 202 by electroplating, electroless plating, chemical vapor deposition, or physical vapor deposition. The function layer 203 can improve silver sintering of the coating structure 20. Furthermore, the function layer 203 is a silver coating layer or a silver alloy coating layer having a thickness that is extremely thin. According to test results, the thickness of the function layer 203 needs to be at least between 0.1 μm and 0.5 μm to have a good silver sintering. Accordingly, the metal cooling substrate 10 can be connected to an insulating substrate 900 of the electric vehicle power module through silver sintering of the function layer 203 of the coating structure 20, so as to achieve high heat conductivity and high reliability, thereby increasing product lifespan.

### Second Embodiment

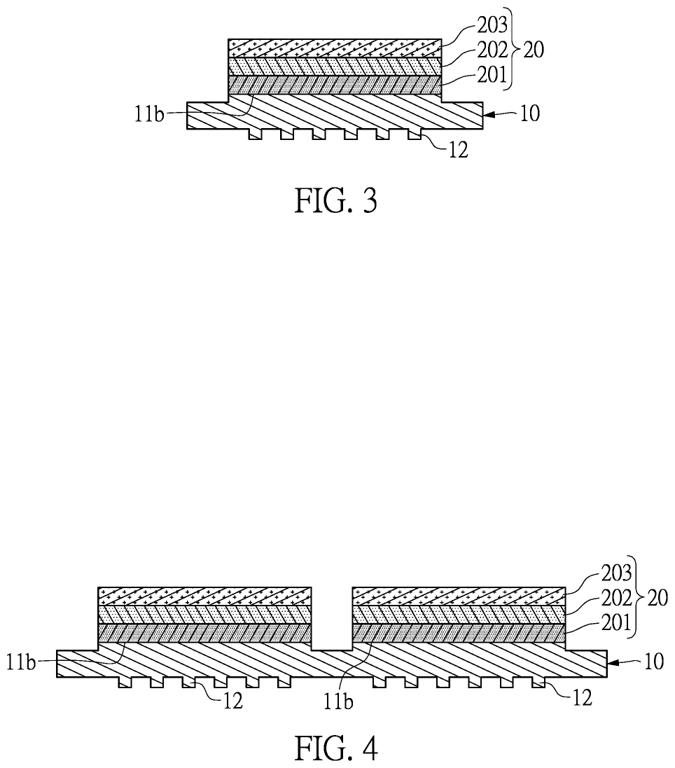

Referring to FIG. 3, a second embodiment of the present disclosure is substantially the same as the first embodiment, and the difference therebetween is described as follows.

In this embodiment, a protruded platform structure 11b is formed on the top surface of the metal cooling substrate 10. In another implementation, at least two protruded platform structures 11b (as shown in FIG. 4) can be formed on the top surface of the metal cooling substrate 10 and spaced apart from each other. Furthermore, the protruded platform structures 11b can be integrally formed on the top surface of the metal cooling substrate 10 through mechanical processing such as skiving. In addition, the protruded platform structures 11b can be integrally formed on the top surface of the metal cooling substrate 10 through forging or stamping. Moreover, the coating structure 20 can be respectively formed on each of the protruded platform structures 11b. The coating structure 20 of this embodiment is substantially the same as in the aforementioned first embodiment, and will not be reiterated herein.

### Third Embodiment

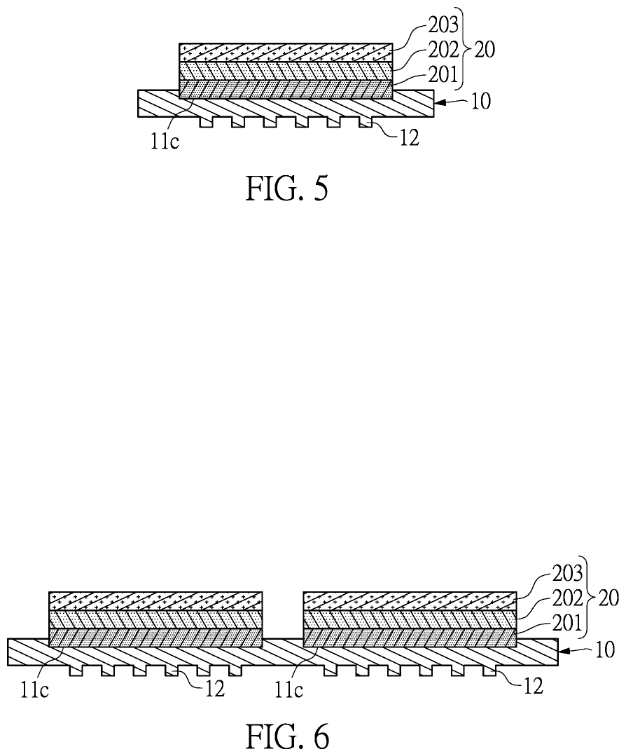

Referring to FIG. 5, a third embodiment of the present disclosure is substantially the same as the first embodiment, and the difference therebetween is described as follows.

In this embodiment, a recessed platform structure 11c is formed on the top surface of the metal cooling substrate 10. In another implementation, at least two recessed platform structures 11c (as shown in FIG. 6) can be formed on the top surface of the metal cooling substrate 10 and spaced apart from each other. Furthermore, the recessed platform structures 11c can be integrally formed on the top surface of the metal cooling substrate 10 through mechanical processing such as skiving. In addition, the recessed platform structures 11c can be integrally formed on the top surface of the metal cooling substrate 10 through forging or stamping. Moreover, the coating structure 20 can be respectively formed in each of the recessed platform structures 11c. The coating structure 20 of this embodiment is substantially the same as in the aforementioned first embodiment, and will not be reiterated herein.

### Fourth Embodiment

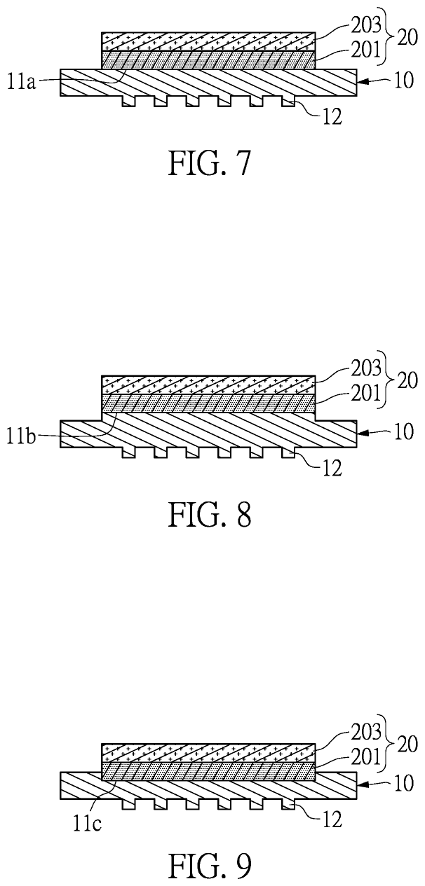

Referring to FIG. 7, a fourth embodiment of the present disclosure is substantially the same as the first embodiment, and the difference therebetween is described as follows.

In this embodiment, the cooler having an optimized coating structure for an electric vehicle power module includes a metal cooling substrate 10 and a coating structure 20 that is at least two-layered.

Furthermore, the coating structure 20 can have at least a barrier layer 201 and a function layer 203. The barrier layer 201 of the coating structure 20 is formed on the platform structure 11a of the metal cooling substrate 10, and the barrier layer 201 is used to impede the diffusion of metal atoms in the metal cooling substrate 10 and prevent the diffused metal atoms from penetrating through the barrier layer 201. The function layer 203 of the coating structure 20 is formed on the barrier layer 201 and can improve copper sintering of the coating structure 20. Moreover, the function layer 203 is a copper coating layer or a copper alloy coating layer having a thickness that is extremely thin. According to test results, the thickness of the function layer 203 needs to be at least between 0.1 μm and 0.5 μm to have a good copper sintering. Accordingly, the metal cooling substrate 10 can be connected to an insulating substrate 900 of the electric vehicle power module through copper sintering of the function layer 203 of the coating structure 20, so as to achieve high heat conductivity and high reliability, thereby increasing product lifespan.

### Fifth Embodiment

Referring to FIG. 8, a fifth embodiment of the present disclosure is substantially the same as the first embodiment, and the difference therebetween is described as follows.

In this embodiment, a protruded platform structure 11b is formed on the top surface of the metal cooling substrate 10, or at least two protruded platform structures 11b can be formed on the top surface of the metal cooling substrate 10 and spaced apart from each other. Moreover, the coating structure 20 can be respectively formed on each of the protruded platform structures 11b. The coating structure 20 of this embodiment is substantially the same as in the aforementioned fourth embodiment, and will not be reiterated herein.

### Sixth Embodiment

Referring to FIG. 9, a sixth embodiment of the present disclosure is substantially the same as the first embodiment, and the difference therebetween is described as follows.

In this embodiment, a recessed platform structure 11c is formed on the top surface of the metal cooling substrate 10, or at least two recessed platform structures 11c can be formed on the top surface of the metal cooling substrate 10 and spaced apart from each other. Moreover, the coating structure 20 can be respectively formed in each of the recessed platform structures 11c. The coating structure 20 of this embodiment is substantially the same as in the aforementioned fourth embodiment, and will not be reiterated herein.

### Beneficial Effects of the Embodiments

In conclusion, in the cooler having an optimized coating structure for an electric vehicle power module provided in the present disclosure, by virtue of “providing a metal cooling substrate and a coating structure having at least a barrier layer and a function layer, the barrier layer being formed on the metal cooling substrate,” “the barrier layer being a nickel coating layer or a nickel alloy coating layer having a thickness of between 0.1 μm and 0.5 μm,” and “the function layer being a silver/silver alloy coating layer, or a copper/copper alloy coating layer having a thickness of between 0.1 μm and 0.5 μm,” a diffusion of metal atom in the metal cooling substrate can be prevented via the barrier capability of the barrier layer of the coating structure. Furthermore, the metal cooling substrate can be connected to an insulating substrate of the electric vehicle power module through silver sintering (or copper sintering) of the function layer of the coating structure, so as to achieve high heat conductivity and high reliability, thereby increasing product lifespan.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A cooler for an electric vehicle power module, comprising:
a metal cooling substrate; and
a coating structure being at least three-layered, and having at least a barrier layer, a connection layer, and a function layer; wherein the barrier layer is formed on the metal cooling substrate, and is a nickel coating layer or a nickel alloy coating layer having a thickness of between 0.1 μm and 0.5 μm; wherein the connection layer is formed on the barrier layer, and is a copper coating layer or a copper alloy coating layer having a thickness of between 0.1 μm and 0.5 μm; wherein the function layer is formed on the connection layer, and is a silver coating layer or a silver alloy coating layer having a thickness of between 0.1 μm and 0.5 μm; wherein the metal cooling substrate is capable of being connected to an insulating substrate of the electric vehicle power module through silver sintering of the function layer of the coating structure.

2. The cooler according to claim 1, wherein the metal cooling substrate is made of copper, copper alloy, aluminum, or aluminum alloy.

3. The cooler according to claim 1, wherein a surface of the metal cooling substrate has at least a platform structure, a protruded platform structure, or a recessed platform structure formed thereon.

4. The cooler according to claim 1, wherein the barrier layer is bonded to the metal cooling substrate by electroplating, electroless plating, chemical vapor deposition, or physical vapor deposition.

5. The cooler according to claim 1, wherein the connection layer is bonded to the barrier layer by electroplating, electroless plating, chemical vapor deposition, or physical vapor deposition.

6. The cooler according to claim 1, wherein the function layer is bonded to the connection layer by electroplating, electroless plating, chemical vapor deposition, or physical vapor deposition.

7. A cooler for an electric vehicle power module, comprising:
a metal cooling substrate; and
a coating structure being at least two-layered, and having at least a barrier layer and a function layer; wherein the barrier layer is formed on the metal cooling substrate, and is a nickel coating layer or a nickel alloy coating layer having a thickness of between 0.1 μm and 0.5 μm; wherein the function layer is formed on the barrier layer, and is a copper coating layer or a copper alloy coating layer having a thickness of between 0.1 μm and 0.5 μm; wherein the metal cooling substrate is capable of being connected to an insulating substrate of the electric vehicle power module by sintering through copper or copper alloy of the function layer of the coating structure.

8. The cooler according to claim 7, wherein the metal cooling substrate is made of copper, copper alloy, aluminum, or aluminum alloy.

9. The cooler according to claim 7, wherein a surface of the metal cooling substrate has at least a platform structure, a protruded platform structure, or a recessed platform structure formed thereon.

10. The cooler according to claim 7, wherein the barrier layer is bonded to the metal cooling substrate by electroplating, electroless plating, chemical vapor deposition, or physical vapor deposition.

11. The cooler according to claim 7, wherein the function layer is bonded to the barrier layer by electroplating, electroless plating, chemical vapor deposition, or physical vapor deposition.
